(19) United States
(12) Patent Application Publication
(10) Pub. No.: US 2021/0080270 A1
(43) Pub. Date: Mar. 18, 2021

(54) SYSTEM, INFORMATION PROCESSING APPARATUS, AND PROGRAM

(71) Applicant: Konica Minolta Inc., Tokyo (JP)

(72) Inventor: Katsuyuki SUGITA, Osaka (JP)

(21) Appl. No.: 16/990,571

(22) Filed: Aug. 11, 2020

(30) Foreign Application Priority Data
Sep. 17, 2019 (JP) 2019-168219

(51) Int. Cl. G01C 21/34; G06Q 10/10

(52) U.S. Cl. CPC G01C 21/3438; G06Q 10/1095; G01C 21/3423; G01C 21/3453

(57) ABSTRACT

A system includes: a hardware processor that: determines whether a schedule of a first user related to handling confidential information has occurred, based on a schedule of an action corresponding to each of a plurality of users; and determines whether a second user is on a first moving body carrying the first user based on a boarding/alighting schedule of moving bodies each moving along a route on a map; and a movement information setter that sets movement information related to movement of each of the moving bodies, wherein the movement information setter sets, when the first user is determined to be scheduled to handle the confidential information while being in the first moving body with the second user also being in the first moving body, the movement information to make the first moving body and a second moving body for transfer meet.

The entire disclosure of Japanese patent Application No. 2019-168219, filed on Sep. 17, 2019, is incorporated herein by reference in its entirety.

### BACKGROUND

### Technological Field

The present disclosure relates to a system, an information processing apparatus, and a program, and more particularly, to a system, an information processing apparatus, and a program capable of setting information about a movement of a moving body.

### Description of the Related Art

As one form of the sharing economy, there has been proposed a system of providing users traveling to the same destination with a moving body such as a vehicle they can ride together.

For example, Japanese Unexamined Patent Publication No. 2019-007761 provides a carpool system in which at least a carpooler that was determined to match a condition at a reservation can ride a reserved vehicle. Furthermore, Japanese Patent Application Laid-Open No. 2003-044702 provides a system that enables users to carpool as desired, only by issuing a desired carpooling condition.

A user sharing a ride may come across a scene where he or she needs to handle confidential information. There has been a demand for protecting the information from security risks such as leakage of the information to other users in the vehicle. Neither of Japanese Patent Laid-Open No. 2019-007761 or Japanese Patent Laid-Open No. 2003-044702 can meet such a need.

### SUMMARY

An object of the present disclosure is to provide a system, an information processing apparatus, and a program with which information handled by a user in a moving body can be protected from security risks.

To achieve the abovementioned object, according to an aspect of the present invention, a system reflecting one aspect of the present invention comprises: a hardware processor that: determines whether a schedule of a first user related to handling confidential information has occurred, based on a schedule of an action corresponding to each of a plurality of users; and determines whether a second user is on a first moving body carrying the first user based on a boarding/alighting schedule of moving bodies each moving along a route on a map; and a movement information setter that sets movement information related to movement of each of the moving bodies, wherein the movement information setter sets, when the first user is determined to be scheduled to handle the confidential information while being in the first moving body with the second user also being in the first moving body, the movement information to make the first moving body and a second moving body for transfer meet.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a schematic view of a moving body including an information processing apparatus according to the present embodiment and its surrounding environment;

FIG. 2 is a diagram illustrating databases (DBs) in association with a periphery of a management server of a system according to the present embodiment, capable of accessing the DBs;

FIG. 3 is a diagram illustrating an example of a hardware configuration of the information processing apparatus according to the present embodiment;

FIG. 4 is a diagram schematically illustrating an example of the hardware configuration of the management server according to the present embodiment;

FIG. 5 is a diagram schematically illustrating an example of the module configuration of the management server according to the present embodiment;

FIG. 6 is a diagram illustrating an example of a destination DB according to the present embodiment;

FIG. 7 is a diagram illustrating an example of a meeting point DB according to the present embodiment;

FIG. 8 is a diagram illustrating an example of a moving body status DB according to the present embodiment;

FIG. 9 is a diagram illustrating an example of a boarding/alighting schedule management DB and a user schedule DB according to the present embodiment;

FIG. 10 is a diagram illustrating another example of the boarding/alighting schedule management DB and the user schedule DB according to the present embodiment;

FIG. 11 is a diagram schematically illustrating a user's boarding/alighting according to the boarding/alighting schedule management DB illustrated in FIG. 9;

FIG. 12 is a diagram schematically illustrating a user's boarding/alighting according to the boarding/alighting schedule management DB illustrated in FIG. 10;

FIG. 13 is a diagram schematically illustrating a cooperative operation of moving bodies according to the present embodiment;

FIG. 14 is a diagram schematically illustrating route setting processing for the cooperative operation according to the present embodiment;

FIG. 15 is a diagram illustrating an example of a processing flowchart according to the present embodiment;

FIG. 16 is a diagram illustrating a case of transfer using public transportation according to the present embodiment; and

FIG. 17 is a diagram schematically illustrating an example of a timetable DB according to the present embodiment.

### DETAILED DESCRIPTION OF EMBODIMENTS

Hereinafter, one or more embodiments of the present invention will be described with reference to the drawings. However, the scope of the invention is not limited to the disclosed embodiments. It should be noted that the same or corresponding parts in the drawings are designated by the same reference numerals and description thereof will not be repeated.

<A. Overview>

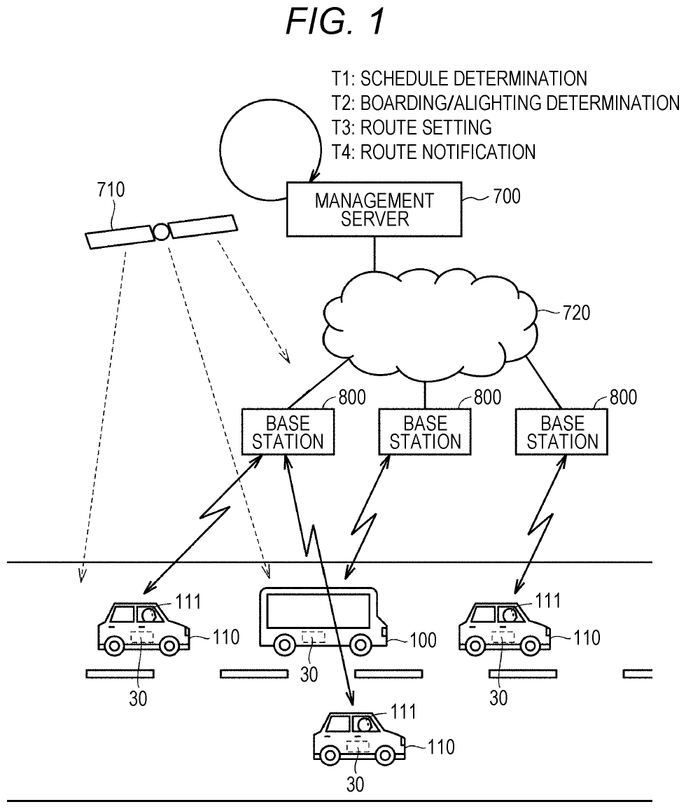

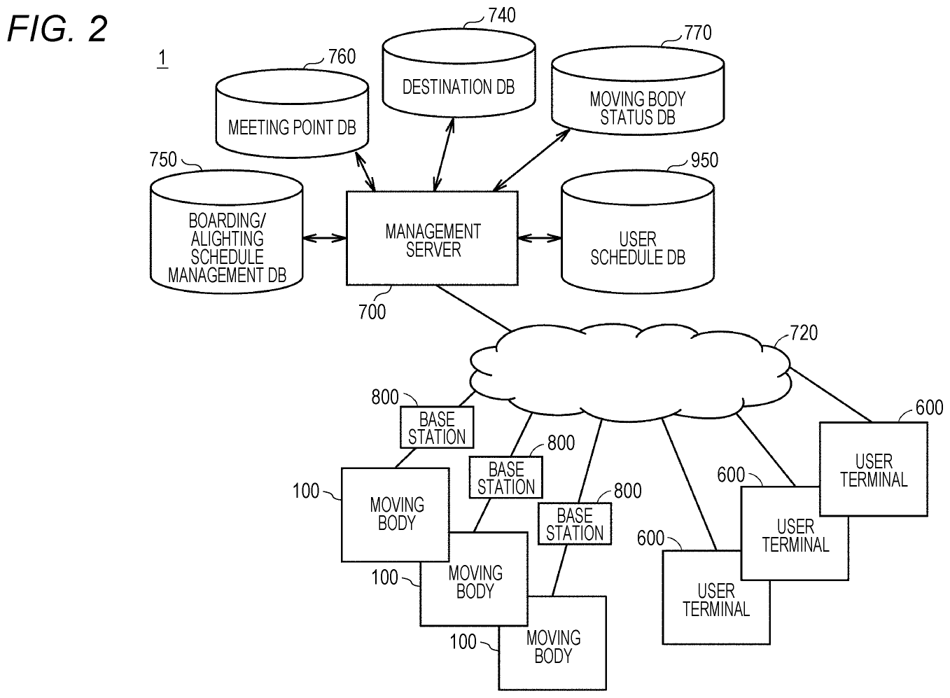

FIG. 1 is a schematic view of a moving body 100 including an information processing apparatus 30 according to the present embodiment and its surrounding environment. FIG. 2 is a diagram illustrating databases (DBs) in association with a periphery of a management server 700 of a system 1 according to the present embodiment, capable of accessing the DB.

In the present embodiment, a “moving body” may include public, private, or autonomous driving transportation, or a transportation manually operated by an operator 111, capable of moving along a route on the map. The moving body may include, but is not limited to, at least one of a vehicle such as an automobile or a motorcycle, a robot, a personal mobility, and the like. The information processing apparatus 30 is a computer installed in the moving body 100. This computer is implemented using, for example, hardware according to a general-purpose architecture. Hereinafter, the information processing apparatus 30 is also abbreviated as the apparatus 30.

In the present embodiment, the “map” is, for example, a road map that is a two-dimensional plane including all or a part of miniaturized routes (corresponding to roads) on which the moving body 100 can travel. On the map, the routes are symbolized and a geographical target is also symbolized at its location on the map. The geographical target may be provided with a name identifying the target. The geographical targets may include, but are not limited to, intersections, rivers, buildings, and the like.

In the present embodiment, the geographical target may enable identification of a “departure point” of the moving body as well as a “meeting point” where the moving bodies 100 meet, “destination”, and the like.

Referring to FIG. 1, there are one or a plurality of other moving bodies 100 (vehicles 110) traveling in the periphery of the moving body 100. The moving body 100 can serve as a mobility office, which is an office environment created inside a movable vehicle. The user can use the mobility office to work (telework) while moving on the moving body 100. Specifically, the work in the vehicle is implemented using information (such as images and voices for video conference or phone calls) communicated over a network 720.

In FIG. 1, the apparatus 30 of the moving body 100 communicates with other apparatuses such as, for example, another moving body 100, the management server 700, and a user terminal 600 over the network 720 such as the Internet and via a plurality of base stations 800. Furthermore, the apparatus 30 detects the position of the host moving body 100 on the map by communicating with a Global Positioning System (GPS) satellite 710, and transmits the detected position to another apparatus including the management server 700 via the closest base station 800. Thus, the management server 700 can manage the position of each moving body.

The user terminal 600 corresponds to a computer with a communication function of a portable type that can be carried around by the user or a built-in computer. The user terminal 600 communicates with other apparatuses over the network 720.

Referring to FIG. 2, the management server 700 provides information to a user riding on the moving body 100, and also refers to various DBs. Examples of such DBs include: a boarding/alighting schedule management DB 750 for managing a boarding/alighting schedule of a user of the moving body 100; a meeting point DB 760 storing information about a meeting point where the moving bodies can meet; a destination DB 740 for managing information about a destination of each moving body 100; a moving body status DB 770 for managing the moving status of each moving body including the position and the speed; and a user schedule DB 950.

The user schedule DB 950 includes a schedule for each user including: the action of the user; information indicating whether the action is related to communicating confidential information; a timing (date and time) when the action is expected to take place. The user schedule DB 950 is managed by the management server 700, but may be managed by a dedicated schedule management server.

In FIG. 1, the management server 700 executes processing for protecting information handled by a user riding on a moving body from security risks such as snooping or wiretapping by another passenger. For example, the management server 700 determines, based on the user schedule DB 950, whether schedule related to handling confidential information has occurred for a first user (step T1), and determines, based on the boarding/alighting schedule management DB 750, whether a second user is also in the moving body 100 carrying the first user (step T2). The management server 700 determines a route on the map corresponding to each moving body 100, and transmits a notification indicating the determined route to the corresponding moving body 100, over the network 720 (steps T3 and T4). When setting the above route, the management server 700 sets a route to a meeting point where a first moving body and a second moving body 100 for transfer meet to at least one of the moving bodies, upon determining that the schedule related to handling confidential information has occurred for the first user who rides on the first moving body 100, and that the second user is also riding the first moving body.

The processing in steps T1 to T4 is not limited to a mode in which the processing is executed by the management server 700 and can be applied to a case where the processing is executed by the apparatus 30 of the moving body 100. In that case, the notification of the route set by the moving body 100 is transmitted to another moving body 100 via the network 720 or the management server 700. Furthermore, the communications between the moving body 100 and the management server 700 may enable a part of the processing in steps T1 to T4 to be executed by the management server 700 and the remaining part to be executed by the moving body 100.

Furthermore, in the above application case, the management server 700 (more specifically, a route setting unit 403 described later) sets (determines) the meeting point, and the apparatus 30 of the moving body 100 may set (determine) the route for moving to the meeting point thus set. Alternatively, the apparatus 30 of the moving body 100 may set the meeting point and the management server 700 may set the route for moving to the meeting point thus set. Route information 315, which will be described later, is an example of “movement information” related to movement of the moving bodies to meet at the meeting point. The route setting unit 403 is an example of “route information setter”. In the present embodiment, the “movement information” includes at least one of the meeting point of the moving bodies and a meeting route that is a movement route in which the moving bodies move to meet at the meeting point. In the following description, it is assumed that the route setting unit 403 sets the meeting point and the meeting route.

With this configuration, in the present embodiment, when the schedule related to handling confidential information occurs for the first user who is moving on the moving body 100, the route to the meeting point where the first moving body meets the second moving body for transfer is determined and at least one of the moving bodies is notified of the route, so that the shared state described earlier can be resolved. Thus, the confidential information handled by the first user can be protected from the security risk such as leakage to a fellow passenger (second user).

Examples of a scene expected to involve such a security risk include: a scene where the user sharing a ride handles information related to operation (work) of his or her organization or company; a scene where the user takes a look at a document with the information printed; and a scene where the user joins a conference or a phone call (video conference or phone conference) involving the information, where the user is transmitting or receiving the information over an email, or the like. Such a scene involves an information security risk such as the information handled by the user in the moving body leaking to a fellow passenger. The present embodiment can prevent such a risk.

<B. Hardware Configuration of Information Processing Apparatus 30>

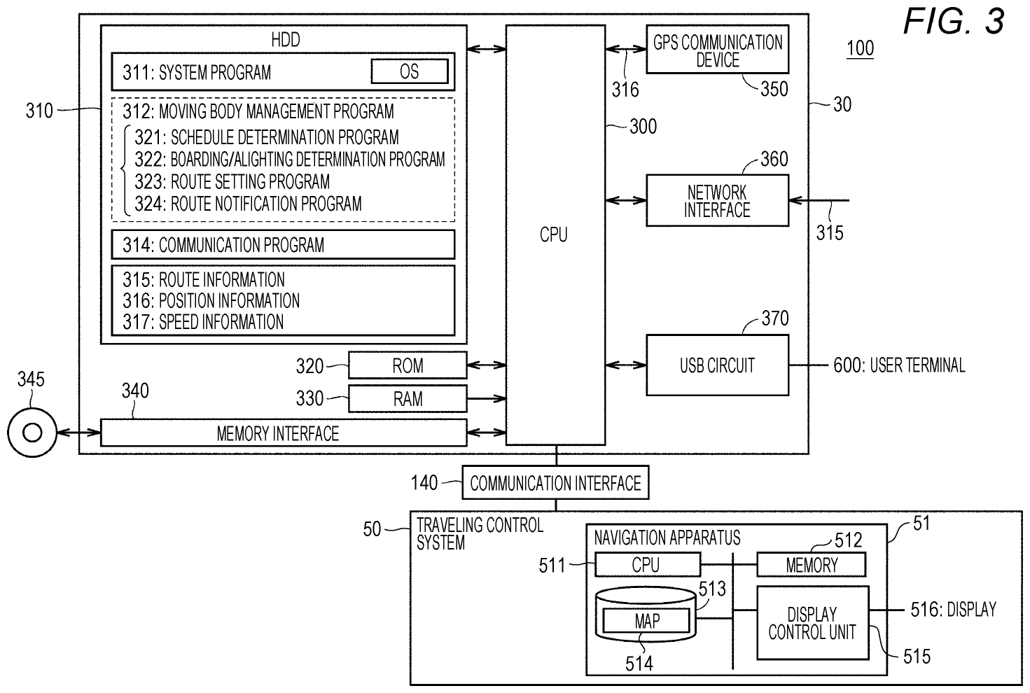

FIG. 3 is a diagram illustrating an example of a hardware configuration of the information processing apparatus 30 according to the present embodiment. Referring to FIG. 3, the apparatus 30 may be connected to a traveling control system 50 that controls traveling of the moving body 100, via a communication interface 140. When the moving body 100 is a vehicle for example, the traveling control system 50 includes a well-known apparatus such as a drive mechanism of a wheel motor, and a navigation apparatus 51. The traveling control system 50 enables the moving body 100 to travel automatically or manually.

The apparatus 30 further includes a Central Processing Unit (CPU) 300, a storage that stores programs and data, a memory interface 340, a Global Positioning System (GPS) communication device 350, a network interface 360, and a Universal Serial Bus (USB) circuit 370. The storage includes a Hard Disk Drive (HDD) 310, a Read Only Memory (ROM) 320, and a Random Access Memory (RAM) 330.

The CPU 300 loads a program stored in the storage, such as the HDD 310, onto the RAM 330, and controls each unit by executing the program thus loaded.

The memory interface 340 includes a driver circuit to which a storage medium 345 is detachably attached. The driver circuit reads data or programs from the attached storage medium 345, or writes data or programs to the storage medium 345. The storage medium 345 is a medium that electrically, magnetically, optically, mechanically, or chemically accumulates information such as a program stored therein, so that the information such as a program can be read by the CPU 300, the other apparatus, machine, and the like.

The GPS communication device 350 receives a signal from the GPS satellite 710 and executes given calculation using the signal to detect the current position of the moving body 100. Position information 316 indicating the current position detected by the GPS communication device 350 is output to the CPU 300.

The network interface 360 includes a circuit, a Network Interface Card (NIC) for example, in charge of communications performed between an external network such as the network 720 and the apparatus 30 via the base station 800.

The USB circuit 370 has a connector to which various devices including the user terminal 600 can be connected, and controls communications between the device connected in a wired or wireless manner to the connector and the CPU 31. The standard for communication with the device connected to the apparatus 30 including the user terminal 600 is not limited to USB and may be another standard such as Local Area Network (LAN). In the present embodiment, a mode of connection of the user terminal 600 to the network 720 may include modes such as connecting to the network 720 via the apparatus 30 as illustrated in FIG. 3, connecting to the network 720 not via the apparatus 30, or the like.

The navigation apparatus 51 includes a CPU 511, a memory 512 such as a ROM and a RAM, an HDD 513 that stores various types of data including a map DB 514, and a display control unit 515 that controls a display 516 for the driver's seat. The CPU 511 of the navigation apparatus 51 executes the program to execute navigation processing for the moving body 100 using the position information 316 about the moving body 100 output from the apparatus 30.

The map DB 514 includes map data including a geographical target and position information (for example, GPS position) of each road (route), image data representing a map, and the like. The map data includes position information about stop points on the route. The stop point is a concept including a departure point, a meeting point, and a destination of the moving body 100.

In the navigation processing, the CPU 511 further generates image data indicating the route of the moving body 100 indicated by the route information 315 on the map, based on the route information 315 described later received from the management server 700 and the map DB 514. The display control unit 515 controls the display 516 based on the generated image data. The display 516 for the driver's seat displays an image of a map in which the current position and route of the moving body 100 are indicated. As a result, the operator 111 can drive the moving body 100 along the route, on the map displayed on the display 516, to the meeting point or the destination.

The route information 315 further includes information about speed between points on the route. This point is designated as a GPS position. In the case of autonomous driving, the traveling control system 50 controls the drive mechanism according to the route information 315 so that the moving body 100 travels between points at the speed between the points indicated by the route information 315. In the case of manual driving, the navigation processing results in the display 516 displaying information about designated speed between points. The operator 111 drives the moving body 100 between the points at the designated speed displayed.

The HDD 310 includes a system program 311 including an Operating System (OS), an application program executed by the CPU 300 under the system program 311, the route information 315, the position information 316, and speed information 317. The CPU 300 stores the latest GPS position measured by the GPS communication device 350 in the HDD 310 as the position information 316. Furthermore, the CPU 300 stores the latest speed of the moving body 100, measured (detected) by the traveling control system 50, in the HDD 310 as the speed information 317. As a result, the current (latest) GPS position and speed of the moving body 100 are indicated by the position information 316 and speed information 317, respectively.

The application program of the HDD 310 includes a communication program 314 for implementing communications between the moving body 100 and an external apparatus. The application program may further include a moving body management program 312. The moving body management program 312 includes a schedule determination program 321, a boarding/alighting determination program 322, a route setting program 323, and a route notification program 324. The moving body management program 312, the schedule determination program 321, the boarding/alighting determination program 322, the route setting program 323, and the route notification program 324 are executed to provide functions that are the same as those respectively provided by a moving body management unit 400, a schedule determination unit 401, a boarding/alighting determination unit 402, the route setting unit 403, and a route notification unit 404 of the management server 700 described later and thus the details of these will not be redundantly described.

Thus, in the present embodiment, when the moving body management program 312 is executed in the moving body 100, the function of the moving body management unit 400 can be provided by the moving body 100. In a case described below, the function of the moving body management unit 400 is provided by the management server 700 in response to the execution of the program in the management server 700.

<C. Hardware Configuration of Management Server 700>

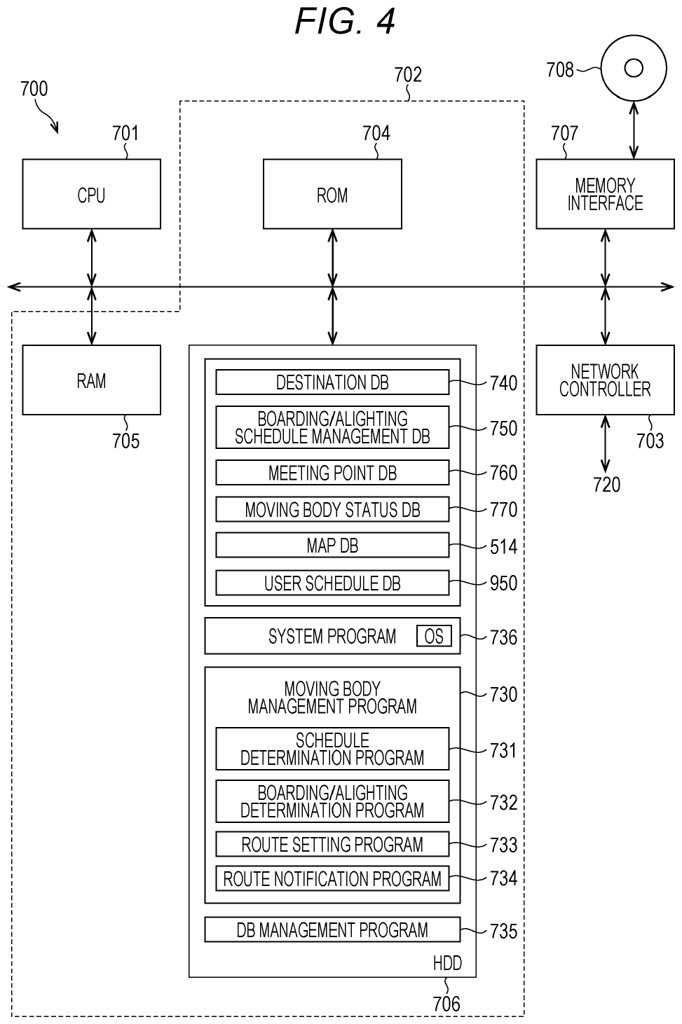

FIG. 4 is a diagram schematically illustrating an example of the hardware configuration of the management server 700 according to the present embodiment. The management server 700 is an example of an “information processing apparatus”. Referring to FIG. 4, the management server 700 includes a CPU 701, a storage unit 702, a network controller 703, and a memory interface 707. The storage unit 702 includes a ROM 704 and a RAM 705 for storing programs and data executed by the CPU 701, as well as an HDD 706 for storing various types of information. The RAM 705 includes an area for storing various types of information and a work area used by the CPU 701 to execute a program. The network controller 703 includes a circuit such as an NIC for communicating with the information processing apparatus 30 over the network 720. The memory interface 707 includes a driver circuit to which a storage medium 708 is detachably attached, reads data or programs from the attached storage medium 708, or writes data or programs to the storage medium 708. The storage medium 708 has the same features as the storage medium 345.

The HDD 706 stores the destination DB 740, the boarding/alighting schedule management DB 750, the moving body status DB 770, the user schedule DB 950, and the map DB 514 illustrated in FIG. 2. The HDD 706 further stores a system program 736 including an OS, as well as a moving body management program 730 and a DB management program 735 executed under the system program 736. The moving body management program 730 includes a schedule determination program 731, a boarding/alighting determination program 732, a route setting program 733, and a route notification program 734 for notifying the moving body of the determined route. The DB management program 735 generates the destination DB 740, the boarding/alighting schedule management DB 750, the moving body status DB 770, and the user schedule DB 950, or updates the data stored in each of the DBs.

<D. Module Configuration of Management Server 700>

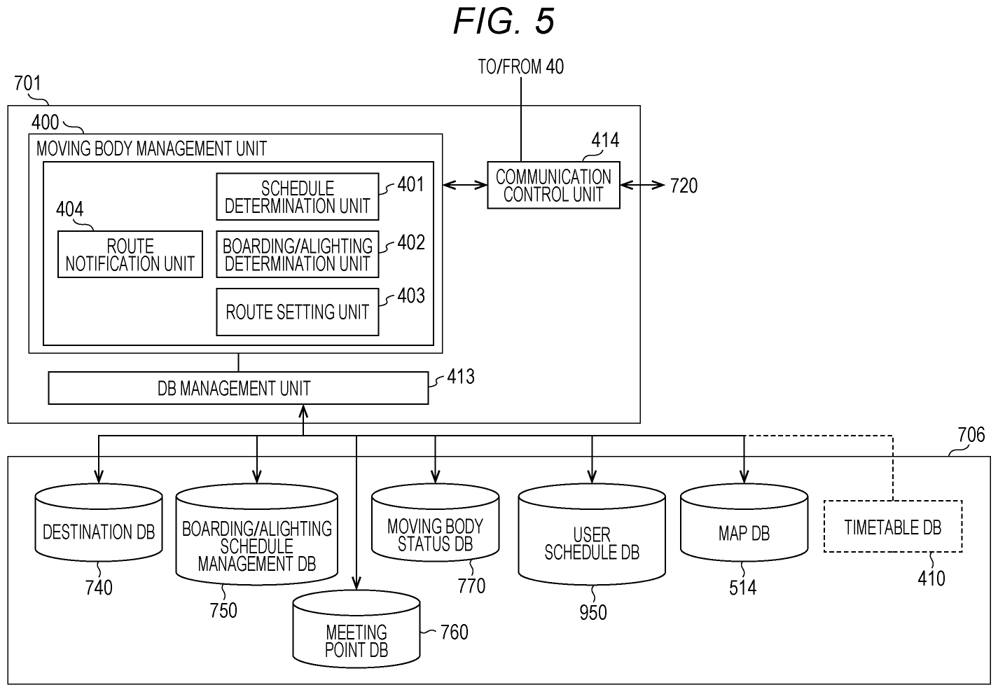

FIG. 5 is a diagram schematically illustrating an example of the module configuration of the management server 700 according to the present embodiment. Referring to FIG. 5, the management server 700 includes the moving body management unit 400 implemented when the CPU 701 executes the moving body management program 730. The moving body management unit 400 includes the schedule determination unit 401 corresponding to the schedule determination program 731, the boarding/alighting determination unit 402 corresponding to the boarding/alighting determination program 732, the route setting unit 403 corresponding to the route setting program 733, and the route notification unit 404 corresponding to the route notification program 734. The management server 700 further includes a DB management unit 413 generated when the CPU 701 executes the DB management program 735 and a communication control unit 414. Each unit of the moving body management unit 400 is implemented when the CPU 701 executes the corresponding program.

The route setting unit 403 searches the map data of the map DB 514 for a guide route from the position of the moving body 100 to the destination or the meeting point. Thus, the route is determined. Furthermore, based on the map data, the route setting unit 403 calculates a distance on the determined route, and a distance between points on the route (for example, between the position of the moving body 100 and the meeting point, between the meeting points, or between the meeting point and the destination), based on the map data.

The communication control unit 414 controls the network controller 703. Although not limited to this, the DB management unit 413 operates according to a database operating language such as a SQL for example, to access the destination DB 740, the boarding/alighting schedule management DB 750, the meeting point DB 760, the moving body status management DB 770, the user schedule DB 950, and the map DB 514 in response to a request (write request or read request) received from the moving body management unit 400 or the communication control unit 414. The write request includes information to be written to the DB, and the read request includes data designating information to be read from the DB. Thus, the DB management unit 413 can update information in a DB and can also read requested information from a DB and output the information to the source of the request, by accessing the DB in response to the received request.

The plurality of DBs stored in the HDD 706 may further include a timetable DB 410 that stores timetable data that is an example of an operation schedule of public transportation described later. When the timetable DB 410 is stored in the HDD 706, the DB management unit 413 can access the timetable DB 410 in response to the request described above.

In the present embodiment, the plurality of DBs described above are managed by the management server 700, but may alternatively be managed by a dedicated DB server instead of the management server 700. In that case, the DB server is in charge of the function of the DB management unit 413.

While an example of the configuration where the required functions are provided with a processor circuit such as the CPU 701 executing the program is illustrated in FIG. 5, all or a part of these functions provided may be implemented using a dedicated hardware circuit (such as an Application Specific Integrated Circuit (ASIC) or a Field-Programmable Gate Array (FPGA)).

<E. Information in DB>

An example of information in the destination DB 740, the boarding/alighting schedule management DB 750, the meeting point DB 760, the moving body status DB 770, and the user schedule DB 950 according to the present embodiment will be described.

(e1. Destination DB 740)

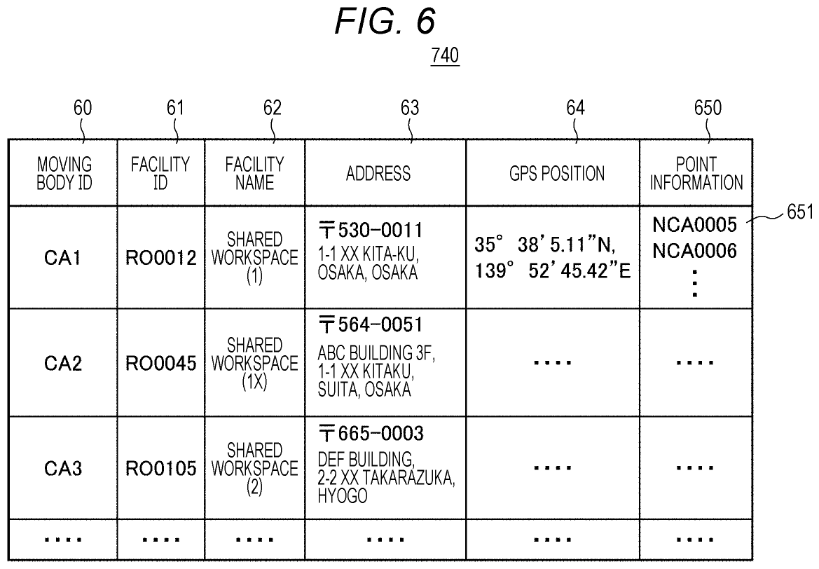

FIG. 6 is a diagram illustrating an example of the destination DB 740 according to the present embodiment. Referring to FIG. 6, the destination DB 740 stores for each moving body 100, information associated with each of a plurality of candidates of the destination of the moving body on the map. The destination in the present embodiment is, without limitation, a geographical target including a facility such as a building for example.

The destination DB 740 includes, for each moving body 100: a moving body ID 60 for identifying the moving body 100; a facility ID 61 for identifying the facility as the destination of the moving body 100; a name 62 of the facility; an address 63 of the facility; a GPS position 64 which is the position of the facility identified by GPS; and point information 650. The point information 650 includes an identifier 651 identifying one or more points that can be set on the route to the destination, including a ride sharing station where the user gets on or off the moving body. The point information 650 includes point identifiers 651 in ascending order of distance from the departure point of the moving body 100 (one closer to the departure point is higher). The identifier 651 includes the name and the GPS position of the point. This point may include a meeting point.

(e2. Meeting point DB 760)

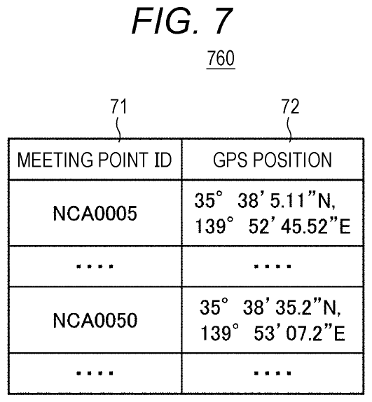

FIG. 7 is a diagram illustrating an example of the meeting point DB 760 according to the present embodiment. Referring to FIG. 7, the meeting point DB 760 stores information associated with each of a plurality of candidates that can be the meeting point of the moving bodies on the map. In the present embodiment, the meeting point is, without limitation, a geographical target where the user comes to get on the moving body 100, and includes, for example, the above-mentioned ride sharing station, a facility building, and the like.

The meeting point DB 760 includes, for each of the plurality of meeting point candidates: a meeting point ID 71 identifying the geographical target as the candidate; and a GPS position 72 that is a position of the meeting point identified by the GPS.

(e3. Moving Body Status DB 770)

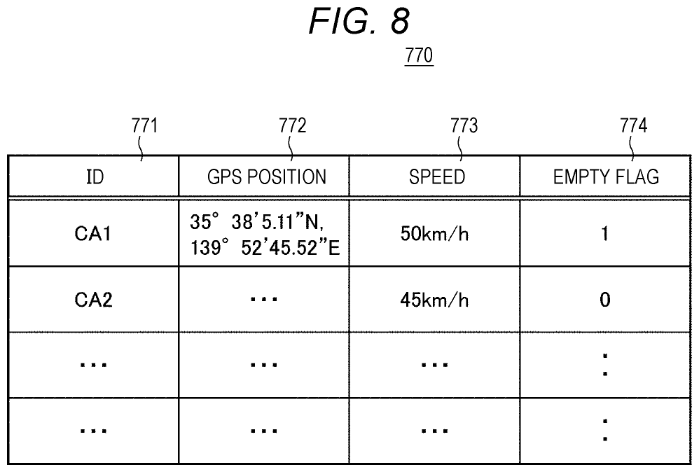

FIG. 8 is a diagram illustrating an example of the moving body status DB 770 according to the present embodiment. Referring to FIG. 8, the moving body status DB 770 includes, for each moving body 100: an ID 771 identifying the moving body 100; and status information. The ID 771 includes the name, communication address, and the like of the moving body 100. The status information includes the current GPS position 772, the current speed 773, and an empty flag 774 of the corresponding moving body 100. The empty flag 774 indicates a state in which the moving body 100 has no user other than the operator 111.

The apparatus 30 of the moving body 100 periodically transmits the position information 316 and the speed information 317 in the HDD 310 to the management server 700. The DB management unit 413 of the management server 700 stores the position information 316 and the speed information 317 received from the moving body 100 in the moving body status DB 770, as the GPS position 772 and the speed 773 in association with the ID 771 of the moving body. As a result, the current position and speed of each moving body 100 is indicated by the information in the moving body status DB 770.

(e4. Boarding/Alighting Schedule Management DB 750 and User Schedule DB 950)

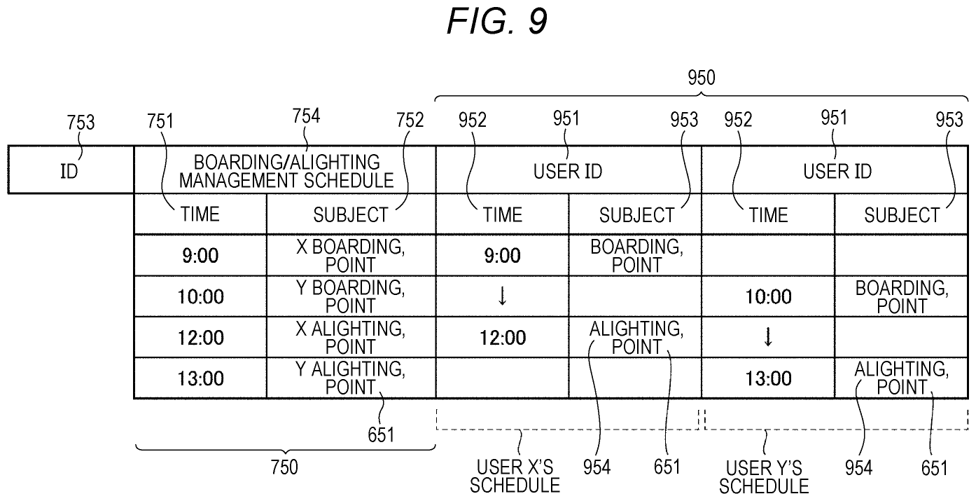

FIG. 9 is a diagram illustrating an example of the boarding/alighting schedule management DB 750 and the user schedule DB 950 according to the present embodiment. In FIG. 9, the user schedule DB 950 is illustrated in association with the boarding/alighting schedule management DB 750.

Referring to FIG. 9, the boarding/alighting schedule management DB 750 includes, for each of the plurality of moving bodies 100: an identifier (ID) 753 identifying the moving body 100; and a boarding/alighting schedule 754. The boarding/alighting schedule 754 includes time 751 and subject 752. The subject 752 indicates the action of the user scheduled at the corresponding time 751, and specifically includes the user's identifier (for example, user name) and the action (identifier 651 of the boarding/alighting point). The boarding/alighting schedule management DB 750 in FIG. 9 includes the boarding/alighting schedule of a single moving body 100, but this is merely an example, and also includes schedules of other moving bodies 100.

The user schedule DB 950 includes a schedule corresponding to each user. The schedule corresponding to the user includes user ID 951, time 952 and subject 953. The subject 953 indicates a user's action scheduled at the corresponding time 952, and specifically includes an action 954 (e.g., boarding/alighting and an identifier 651 of the boarding/alighting point). FIG. 9 illustrates the schedules of a user X and a user Y, but this is merely an example, and the user schedule DB 950 also includes schedules of other users.

When the user operates the user terminal 600 and requests the management server 700 for schedule registration, the DB management unit 413 transmits the destination DB 740 of the HDD 510 to the user terminal 600. The information in the destination DB 740 is displayed on a display (not illustrated) of the user terminal 600. Based on the displayed information (such as the name 62 and the address 63 of the facility as well as the point identifier 651), the user selects the moving body ID 60 of the moving body 100 going to the destination that matches the user's schedule, the boarding time 952 and the identifier 651 of the boarding point, and the alighting time 952 and the identifier 651 of the alighting point.

The user operates the user terminal 600 to transmit the schedule information, which is the information thus selected, to the management server 700. The DB management unit 413 updates (by adding and changing) the user schedule DB 950 using the schedule information received from the user terminal 600. The DB management unit 413 uses the schedule of each user in the user schedule DB 950 (moving body ID 60, time 952, and subject 953) to update boarding/alighting schedule 754 corresponding to the ID 753 matching the moving body ID 60 in the boarding/alighting schedule management DB 750. Thus, the DB management unit 413 can hold (store) the information in the boarding/alighting schedule management DB 750 in association with the user schedule DB 950, and update the information in the boarding/alighting schedule management DB 750 in synchronization with the user schedule DB 950.

In the present embodiment, the DB management unit 413 determines whether each moving body 100 is empty based on the boarding/alighting schedule 754 of each moving body in the boarding/alighting schedule management DB 750. When the moving body 100 is determined to be empty, the DB management unit 413 sets “1” to the empty flag 774 corresponding to the ID 771 in the moving body status DB 770 matching the ID 753 of the moving body 100. When the moving body 100 is determined not to be empty, the DB management unit 413 sets “0” to the empty flag 774.

It can be seen in FIG. 9 that users (X and Y) are scheduled to use the same moving body 100, so that the moving body 100 is in a shared state from 10:00 to 12:00.

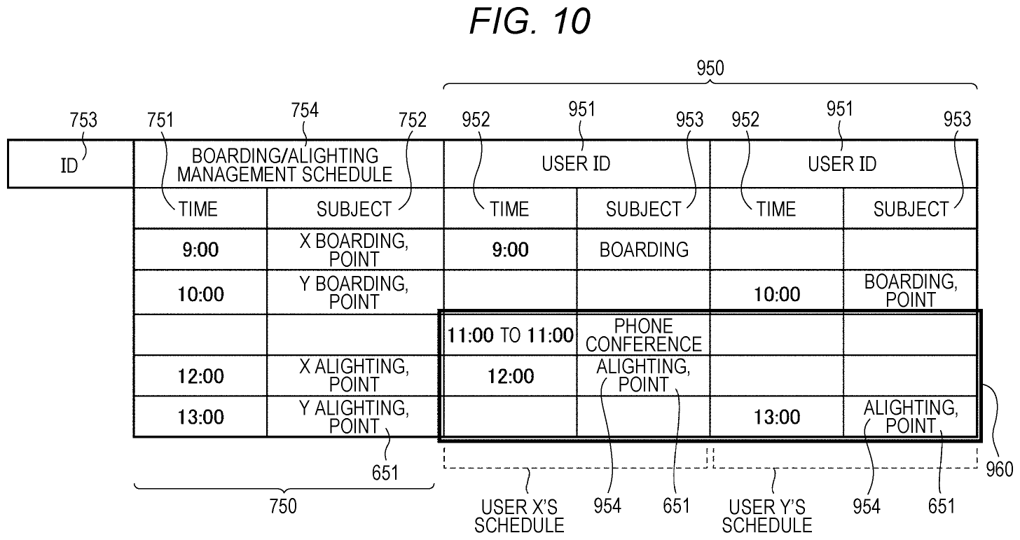

FIG. 10 is a diagram illustrating another example of the boarding/alighting schedule management DB 750 and the user schedule DB 950 according to the present embodiment. The schedule in FIG. 10 has the schedule of user X in addition to the schedule in FIG. 9. The added schedule of the user X includes an action 954 (phone conference) for handling the confidential information starting at 11:00 to 11:00. Thus, the action 954 for handling the confidential information is scheduled to start within the shared time zone.

In the present embodiment, the time zone in which the action 954 for handling confidential information is scheduled to take place is defined as a risk time zone 960 involving a high risk of leakage of the confidential information to another sharing user (user Y in FIG. 10). In FIG. 10, for example, the risk time zone 960 is from the scheduled start time of the phone conference to the scheduled alighting time of the user Y, that is, from 11:00 to 13:00. In the embodiment, the management server 700 executes route setting processing of the moving body 100 to transfer a user sharing a ride to another moving body, so that the moving body 100 can be prevented from being in the shared state in the risk time zone 960. Furthermore, for a user scheduled to be getting on the moving body in the risk time zone 960, another moving body is allocated.

In the present embodiment, when the user registers a schedule in the user schedule DB 950, a flag indicating whether his or her action involves handling the confidential information, is included in the action 954. Thus, the management server 700 can determine whether or not the action 954 is an action involving handling confidential information based on the flag in the action 954. Furthermore, determination on whether the action 954 involves handling confidential information is not limited to the determination method based on the flag. For example, the determination method may be a method based on whether the type of the action 954 matches a predetermined action type. Furthermore, the determination method may be, for example, a method based on whether participants of the phone conference which is the action 954 include a predetermined member. Alternatively, for example, when the action 954 is a video conference or a web conference, the determination method may be a method based on a result of determining whether the information about the communication address for the video conference or the web conference includes information corresponding to a predetermined website.

<F. Meet and Transfer>

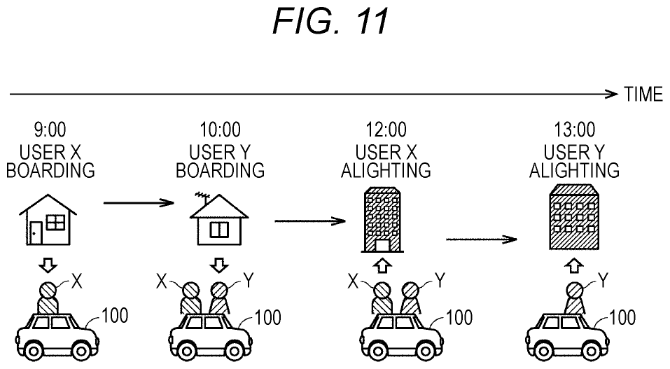

How the moving bodies 100 meet and how transfer takes place according to the present embodiment will be described in association with the boarding/alighting schedule management DB 750 illustrated in FIGS. 9 and 10. FIG. 11 is a diagram schematically illustrating a user's boarding/alighting according to the boarding/alighting schedule management DB 750 illustrated in FIG. 9. In FIG. 11, the user X and the user Y each get on the moving body 100 at the ride sharing station based on the boarding/alighting schedule management DB 750 of the moving body 100 (that is, according to their own user schedule), and get off the moving body 100 so that the shared time ends.

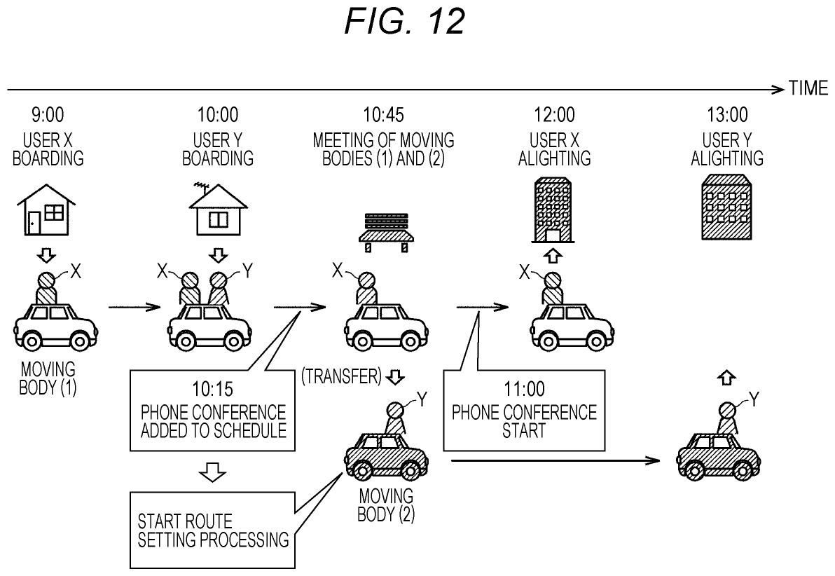

FIG. 12 is a diagram schematically illustrating a user's boarding/alighting according to the boarding/alighting schedule management DB 750 illustrated in FIG. 10. In FIG. 12, the user X and the user Y get on the moving body 100 at the closest ride sharing station, in accordance with the boarding/alighting schedule management DB 750 of the first moving body 100 (referred to as a moving body (1)) (that is, in accordance with his or her user schedule).

Then, when the scheduled action of “start phone conference at 11:00” is added to the schedule of the user X in the user schedule DB 950 at 10:15 for example, the management server 700 starts cooperative processing to make the second moving body 100 (referred to as a moving body (2)) meet the moving body (1) before the phone conference start time.

In the present embodiment, the first moving body 100 and the second moving body 100 to meet operate in cooperation. The moving bodies that thus operate in cooperation with are also referred to as “cooperating moving bodies”.

In FIG. 12, the cooperative operation results in the moving body (1) and the moving body (2) meeting at 10:45 before the scheduled start time (11:00) of the phone conference, and the user Y transfers from the moving body (1) to the moving body (2) at the meeting point. Thus, the shared state of the moving body (1) is resolved, and then the user X starts the phone conference in the moving body (1). Thus, also in the moving body 100 that can be shared among users, the information handled by the user in the moving body 100 can be protected from the security risk such as information leakage to a fellow passenger.

<G. Cooperative Operation of Moving Bodies>

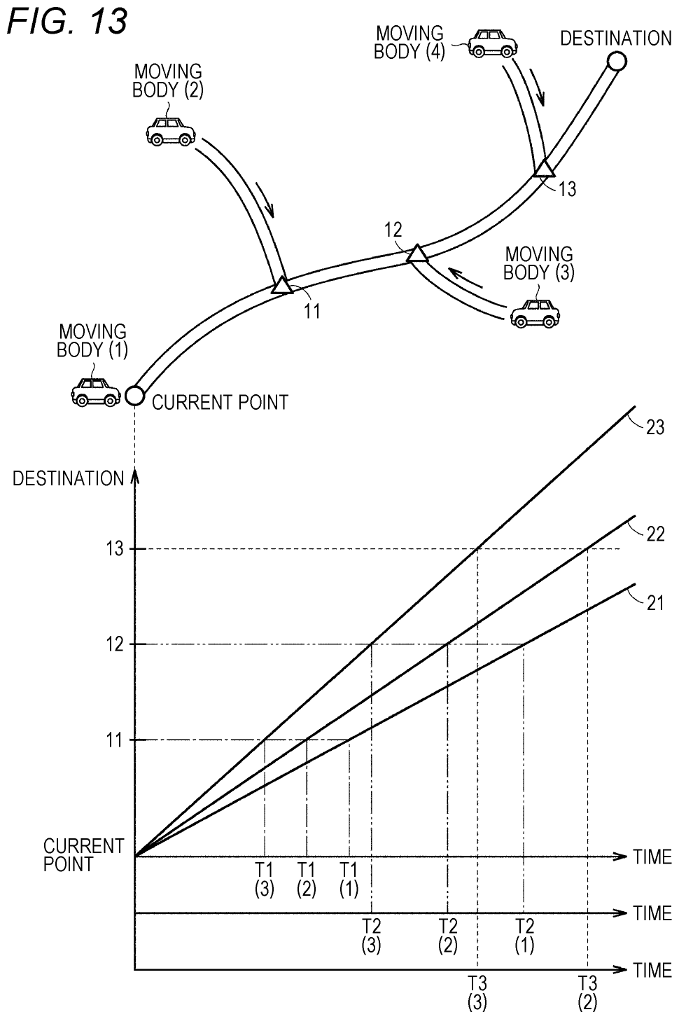

FIG. 13 is a diagram schematically illustrating the cooperative operation of the moving bodies according to the present embodiment. Referring to FIG. 13, a cooperative operation for the moving body (1) and another moving body to meet will be described. The upper part of FIG. 13 illustrates the moving body (1) moving on the route 10 from the current position to the destination, with meeting points 11, 12, and 13 arranged on the route 10 in this order from the side closer to the current position of the moving body (1). The moving body (2), a moving body (3) that is a third moving body 100, and a moving body (4) that is a fourth moving body 100 are respectively illustrated at the meeting points 11 to 13, as cooperating moving bodies that meet the moving body (1). The moving bodies (2) to (4) are assumed to be empty for the sake of simplicity.

The lower part of FIG. 13 illustrates the scheduled arrival times at the meeting points 11 to 13 respectively being associated with first speed 21, second speed 22, and third speed 23 (where first speed 21<second speed 22<third speed 23) of the moving body (1) moving on the route 10 from the current position at the speed 773 that is constant legal speed. It is assumed that the route of the moving body involves no traffic jam, or refueling (charging) at an intermediate point.

The scheduled arrival time of the moving body (1) at the meeting point 11 includes time T1(1), time T1(2), and time T1(3) respectively corresponding to the first speed 21, the second speed 22, and the third speed 23 (where, T1(1)>T1(2)>T1(3)) as the constant speed 773. Similarly, the scheduled arrival time of the moving body (1) at the meeting point 12 includes time T2(1), time T2(2), and time T2(3) respectively corresponding to the first speed 21, the second speed 22, and the third speed 23 (where, T2(1)>T2(2)>T2(3)) as the constant speed 773. Similarly, the scheduled arrival time of the moving body (1) at the meeting point 13 includes time T3(1), time T3(2), and time T3(3) respectively corresponding to the first speed 21, the second speed 22, and the third speed 23 (where, T3(1)>T3(2)>T3(3)) as the constant speed 773. Note that T1(3)<T2(3)<T3(3).

As described above, the arrival time of the moving body (1) at the meeting point varies depending on the speed 773 of the moving body (1) even if the meeting point is the same. Thus, the management server 700 executes the route setting processing in which the route or the speed and the route of the cooperating moving bodies are changed so that the cooperating moving bodies can arrive at the meeting point at the scheduled arrival time.

<H. Route Setting Processing>

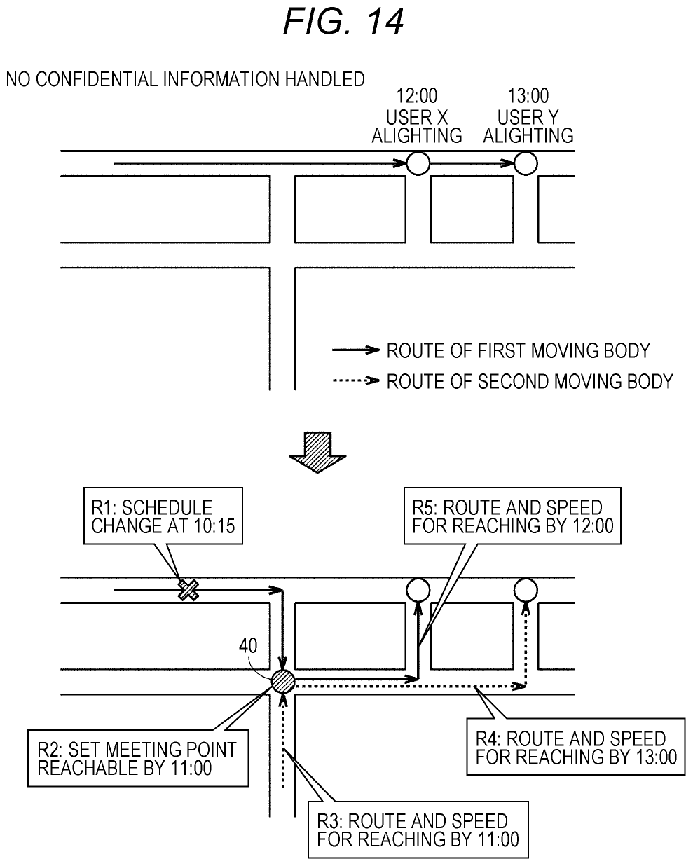

FIG. 14 is a diagram schematically illustrating route setting processing for the cooperative operation according to the present embodiment. The route setting processing executed by the route setting unit 403 will be described with reference to FIG. 14. When the user schedule DB 950 includes no action 954 involving handling confidential information as illustrated in FIG. 9, the route setting unit 403 calculates the route 10 from the current point (departure point) of the first moving body 100 (moving body (1)) to the destination in accordance with the boarding/alighting schedule management DB 750 illustrated in FIG. 9, as illustrated in the upper part of FIG. 14. Furthermore, for enabling the first moving body 100 to arrive at a point identified by the identifier 651 of the corresponding point at each time 751 in the boarding/alighting schedule management DB 750, the route setting unit 403 calculates the speed of the moving body 100 travelling between points based on the distance between the points on the route 10 and the time 751. The route notification unit 404 transmits the route information 315 including the route 10 and the information about the speed between the points determined by the route setting unit 403, to the first moving body 100. As a result, the first moving body 100 changes the traveling speed between the points and executes navigation processing according to the route information 315 received from the management server 700.

As illustrated in the lower part of FIG. 14, a phone conference handling confidential information is added to the schedule of the user X while the first moving body 100 is moving on the route (step R1). The route setting unit 403 executes the route setting processing (steps R2, R3, R4, and R5) to make the first moving body 100 meet the second moving body 100 to which the user is transferred, for resolving the shared state of the first moving body 100. Here, the meeting point is off the original route of the first moving body 100.

First of all, the route setting unit 403 determines the closest meeting point 40 at which the first moving body 100 can arrive before the start time (11:00) of the phone conference, that is, before the risk time zone 960 starts (step R2).

Specifically, the route setting unit 403 reads the GPS position 772 corresponding to the ID 771 that matches the moving body ID 60 of the first moving body 100, from the moving body status DB 770. Based on the difference (distance) between the corresponding GPS position 72 and GPS position 772 and on the speed of the first moving body 100, the route setting unit 403 calculates a time required for reaching each meeting point in the meeting point DB 760. The route setting unit 403 determines one or more meeting point candidates that can be reached before the start of the phone conference, based on the required time calculated for each meeting point. In the present embodiment, the meeting point 40 closest to the current position of the first moving body 100 (that is, the GPS position 772) is extracted (determined) from the one or more meeting point candidates.

The route setting unit 403 identifies the moving body closest to the meeting point 40 (this is referred to as the second moving body 100), and determines the route to the destination of the user via the meeting point 40 based on the position of the second moving body 100 and the speed (steps R3 and R4). Here, the user X stays in the first moving body 100, and the user Y transfers to the second moving body 100 at the meeting point 40.

Specifically, the route setting unit 403 searches the moving body status DB 770. Based on the result of the search, the ID 771 of one moving body 100 corresponding to the GPS position 772 indicating position closest to the GPS position 72 of the meeting point 40, among one or more moving bodies 100 with the empty flag 774 set to “0” is read from the moving body status DB 770. Thus, the second moving body is determined.

The route setting unit 403 calculates (determines) a route and distance from the GPS position 772 of the second moving body 100 to the destination of the user Y via the meeting point 40, based on the map DB 514. Based on the determined distance to the meeting point 40, the route setting unit 403 calculates the speed resulting in expected arrival time of the second moving body 100 at the meeting point 40 being earlier than the phone conference start time (11:00). Furthermore, based on the determined distance from the meeting point 40 to the destination, the route setting unit 403 calculates the speed resulting in the expected arrival time of the second moving body 100 at the destination being no later than the scheduled time (13:00) of the user Y.

The route notification unit 404 transmits the route information 315 indicating the route and speed determined for the second moving body 100 by the route setting unit 403, using the communication address indicated by the ID 771 of the second moving body 100.

The route setting unit 403 also calculates (determines) a route and distance from the GPS position 772 of the first moving body 100 to the destination of the user X via the meeting point 40, based on the map DB 514. Based on the determined distance to the meeting point 40, the route setting unit 403 calculates the speed resulting in expected arrival time of the first moving body 100 at the meeting point 40 being earlier than the phone conference start time (11:00). Furthermore, based on the determined distance from the meeting point 40 to the destination of the user X, the route setting unit 403 calculates the speed resulting in the expected arrival time of the first moving body 100 at the destination being no later than the scheduled time (12:00) of the user X (step R5).

The route notification unit 404 transmits the route information 315 indicating the route and speed determined for the first moving body 100 by the route setting unit 403 using the communication address indicated by the ID 771 of the first moving body 100.

In this manner, when the meeting point 40 is off the original route of the first moving body 100, the route setting unit 403 resets the route and the speed of the first moving body 100. When the meeting point 40 is on the original route, the route setting unit 403 may reset the route to change the final destination to the destination of the user X.

Furthermore, in FIG. 14, the user Y transfers to the second moving body 100, but the present invention is not limited to this, and the user X may transfer to the second moving body 100. Also in such a case, the route setting unit 403 executes the processing of resetting the routes or speeds of the first moving body 100 and the second moving body 100, as in the case described above. Furthermore, the route setting unit 403 may set the route so that the first moving body 100 and the second moving body 100 for transfer meet within a predetermined period of time after the scheduled start time, instead of setting the route so that they meet before the scheduled start time as described above.

<I. Flowchart>

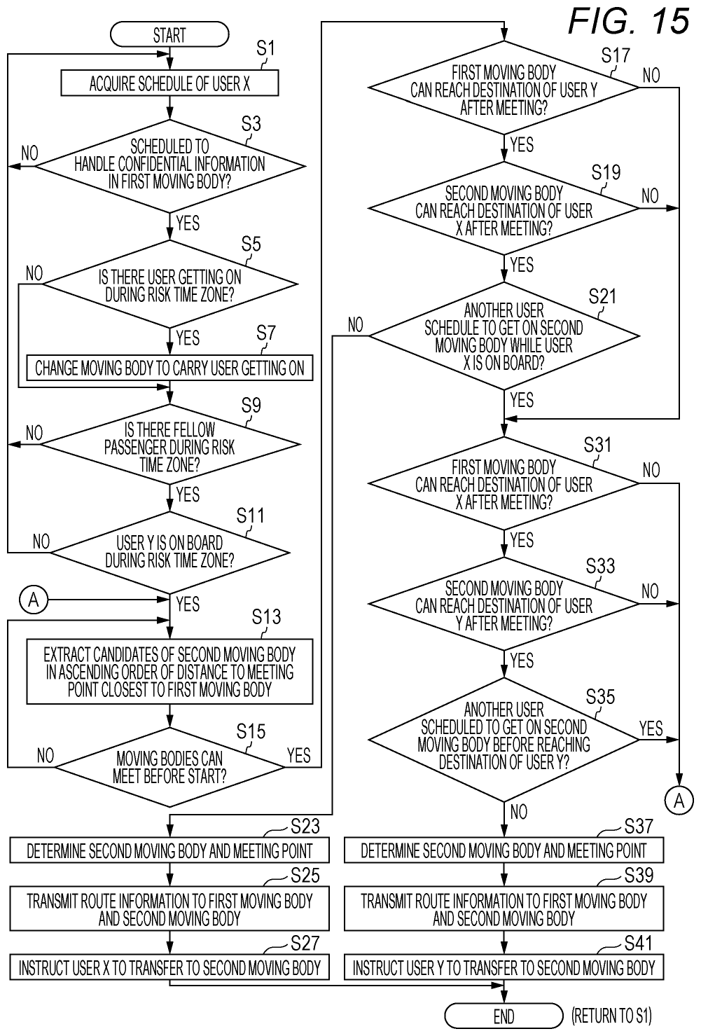

FIG. 15 is a diagram illustrating an example of a processing flowchart according to the present embodiment. The flowchart mainly illustrates the processing executed by the moving body management unit 400. Here, the schedule (the time 952 and the action 954) for using the first moving body 100 carrying the user X is registered to the user schedule DB 950.

First of all, the schedule determination unit 401 searches (acquires) the user schedule DB 950 for the schedule of the user X registered as described above (step S1), and determines whether the user X is scheduled to handle confidential information based on the action 954 in the schedule of the user X found (step S3). When it is determined that the schedule does not include handling of the confidential information (NO in step S3), the processing returns to step S1.

The schedule determination unit 401 determines that the schedule includes handling of confidential information (YES in step S3), based on associating information associating the user schedule DB 950 in FIG. 9 or 10 with the boarding/alighting schedule management DB 750. The schedule determination unit 401 identifies the risk time zone 960 using the scheduled confidential information handling time, based on the associating information associating the user schedule DB 950 in FIG. 9 or 10 with the boarding/alighting schedule management DB 750. The schedule determination unit 401 searches the associating information based on the risk time zone 960, and based on the search result, determines whether there is a user getting on the first moving body 100 in the risk time zone 960 (Step S5). When the schedule determination unit 401 determines that there is a user getting on the first moving body 100 in the risk time zone 960 (YES in step S5), the moving body management unit 400 allocates another moving body 100 to the user (step S7).

On the other hand, when the schedule determination unit 401 determines that there is no user getting on the first moving body 100 in the risk time zone 960 (NO in step S5), the boarding/alighting determination unit 402 determines whether there is a user sharing the first moving body 100 with the user X based on the associating information described above (step S9). When the boarding/alighting determination unit 402 determines that there is no other user sharing the ride (NO in step S9), the processing returns to step S1.

Upon determining that there is another user sharing the ride (YES in step S9), the boarding/alighting determination unit 402 determines whether the other user is on board during the risk time zone 960 based on the associating information (step S11). When the boarding/alighting determination unit 402 determines that the other user is not on board during the risk time zone 960 (NO in step S11), the processing returns to step S1.

On the other hand, when the other user is determined to be on board during the risk time zone 960 (NO in step S11), the route setting unit 403 executes the route setting processing as illustrated in the lower part of FIG. 14. Here, the other user is referred to as user Y.

Specifically, the route setting unit 403 searches the moving body status DB 770 based on the GPS position of the meeting point 40 closest to the first moving body 100, to extract candidates of the other moving body 100 in ascending order of the distance to the meeting point 40 (step S13). The route setting unit 403 executes the following processing for each candidate moving body thus extracted.

First of all, the route setting unit 403 determines whether the first moving body 100 can meet the candidate moving body at the meeting point 40 before the scheduled confidential information handling start time, for example, before the scheduled start time of the phone conference (step S15). When the route setting unit 403 determines that the candidate moving body cannot meet (NO in step S15), the processing returns to step S13.

Upon determining that the candidate moving body can meet at the meeting point 40 (YES in step S15), the route setting unit 403 determines whether any of the users X and Y can stay in the first moving body 100. According to the lower part of FIG. 14, the route setting unit 403 further sets (changes) the speed of the moving body 100 in the route setting. Still, in the following processing, the route is set so that the users X and Y can arrive at the destination by the scheduled designated time, without changing the speed of the moving body 100.

First of all, the route setting unit 403 determines whether the first moving body 100 arrives at the destination of the user X by the designated time (step S17). Specifically, the route setting unit 403 calculates the route from the position of the first moving body 100 to the destination of the user X via the point 40 and the distance on the route, and calculates the time required for the user X to move to the destination, based on the calculated distance and the speed 773 of the first moving body 100. Based on the calculated required time and the current time, the route setting unit 403 determines whether the first moving body 100 arrives at the destination of the user X by the designated time.

When the route setting unit 403 determines that the first moving body 100 cannot arrive at the destination of the user X by the designated time (NO in step S17), the processing proceeds to step S31 described below.

Upon determining that the first moving body 100 can arrive at the destination of the user X by the designated time (YES in step S17), the route setting unit 403 determines whether the candidate moving body can arrive at the destination of the user X by the designated time (step S19). This determination is made by using the distance on the route from the position of the candidate moving body to the destination of the user X via the point 40 and the speed 773 of the candidate moving body, as in the processing for the first moving body 100 in step S17. Therefore, detailed description will not be repeated for step S17.

When the route setting unit 403 determines that the candidate moving body cannot arrive at the destination of the user X by the designated time (NO in step S19), the processing proceeds to step S31 described below. On the other hand, when the candidate moving body is determined to be capable of arriving at the destination of the user X by the designated time (YES in step S19), the route setting unit 403 searches the boarding/alighting schedule 754 of the candidate moving body in the boarding/alighting schedule management DB 750, and based on the search result, determines whether another user is scheduled to get on the candidate moving body while the user X is on the candidate moving body (that is, during the time of the movement from the meeting point 40 to the destination of the user X) (step S21).

When the route setting unit 403 determines that another user is scheduled to get on the candidate moving body (YES in step S21), the processing proceeds to step S31 described later. On the other hand, when it is determined that no other user is scheduled to get on the candidate moving body (NO in step S21), the route setting unit 403 determines the candidate moving body to be the second moving body 100, and determines the meeting point of the first and the second moving bodies 100 to be the meeting point 40 (step S23).

The route notification unit 404 transmits the route information 315 indicating the route set by the route setting unit 403 to each of the first moving body 100 and the second moving body 100 (step S25). The moving body management unit 400 transmits an instruction to transfer to the second moving body 100, to the user terminal 600 of the user X (step S27). The user terminal 600 outputs the transfer instruction to the user X.

In steps S31 to S41, the route setting unit 403 executes the processing as in steps S17 to S27, for a case where the user Y transfers to the second moving body.

First of all, the route setting unit 403 determines whether the first moving body 100 reaches the destination by the designated time by moving on the route from the position of the first moving body 100 to the destination of the user X via the meeting point 40 (step S31). This determination is made by using the distance on the route from the position of the first moving body 100 to the destination of the user X via the point 40 and the speed 773 of the first moving body 100, as in the processing in step S17. Therefore, detailed description will not be repeated for step S17.

When the route setting unit 403 determines that the first moving body 100 cannot arrive at the destination of the user X via the meeting point 40 by the designated time (NO in step S31), the processing returns to step S13. When the route setting unit 403 determines that the first moving body 100 can reach the destination of the user X via the meeting point 40 by the designated time (YES in step S31), the route setting unit 403 determines whether the candidate moving body can reach the destination of the user Y by the designated time by moving on the route from the meeting point 40 to the destination of the user Y (step S33). This determination is made by using the time calculated by using the distance on the route from the meeting point 40 to the destination of the user X and the speed 773 of the candidate moving body, that is the time required for moving from the meeting point 40 to the destination. This determination is similar to the processing in step S17, and therefore detailed description will not be repeated.

When the route setting unit 403 determines that the candidate moving body cannot arrive at the destination of the user Y by the designated time (NO in step S33), the processing returns to step S13. When the candidate moving body is determined to be capable of arriving at the destination of the user Y by the designated time (YES in step S33), the route setting unit 403 searches the boarding/alighting schedule 754 of the candidate moving body in the boarding/alighting schedule management DB 750, and based on the search result, determines whether another user is scheduled to get on the candidate moving body while the user Y is on the candidate moving body (that is, during the time of the movement from the meeting point 40 to the destination of the user Y) (step S35).

When the route setting unit 403 determines that another user is scheduled to get on the candidate moving body (YES in step S35), the processing proceeds to step S13. When it is determined that no other user is scheduled to get on the candidate moving body (NO in step S35), the route setting unit 403 determines the candidate moving body to be the second moving body 100, and determines the meeting point of the first and the second moving bodies 100 to be the meeting point 40 (step S37).

The route notification unit 404 transmits the route information 315 indicating the route set by the route setting unit 403 to each of the first moving body 100 and the second moving body 100 (step S39). The moving body management unit 400 transmits an instruction to transfer to the second moving body 100, to the user terminal 600 of the user Y (step S41). The user terminal 600 outputs the transfer instruction to the user X.

In FIG. 15, when the processing returns to step S13, the route setting unit 403 executes the processing as in steps S15 to S41 for the next candidate moving body.

<J. Transfer to Public Transportation>

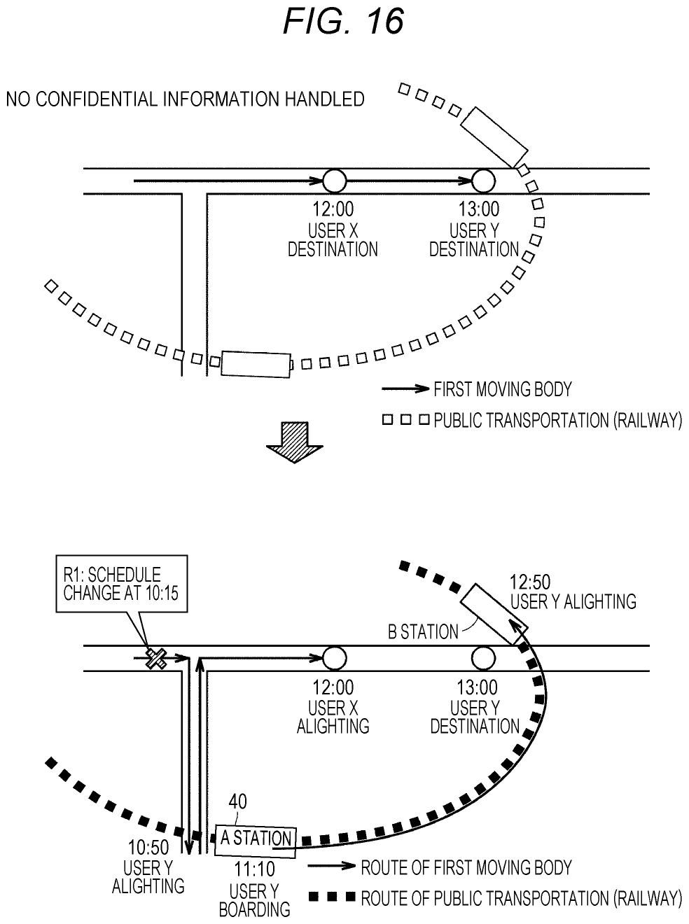

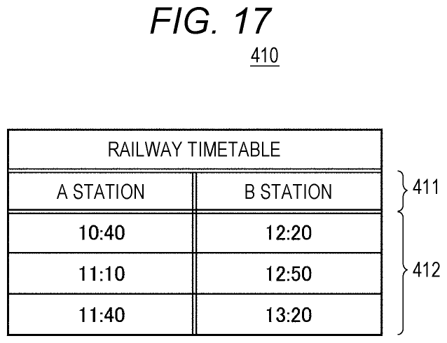

In the present embodiment, the second moving body may include public transportation. FIG. 16 is a diagram illustrating a case of transfer using public transportation according to the present embodiment. This public transportation is, without limitation, a train for example. FIG. 17 is a diagram schematically illustrating an example of the timetable DB 410 according to the present embodiment. Referring to FIG. 17, the timetable DB 410 includes, for each railway station, a station ID 411 and a departure/arrival time 412. The ID 411 includes the GPS position of the station building. In this case, candidates of the meeting point may include a railway station.

As in the upper part of FIG. 14, the upper part of FIG. 17 corresponds to the case where the schedules of the users sharing the first moving body 100 include no action 954 for handling confidential information. Thus, the transfer to the second moving body 100 at the meeting point does not occur.

As illustrated in the lower part of FIG. 14, in the lower part of FIG. 16, a phone conference handling confidential information is added to the schedule of the user X while the first moving body 100 is moving on the route to the destination of the user (step R1). The route setting unit 403 executes the route setting processing to make the first moving body 100 meet the second moving body 100 to which the user is transferred, for terminating the carshare state of the first moving body 100 in the risk time zone 960.

First of all, the route setting unit 403 determines the closest meeting point 40 at which the first moving body 100 can arrive before the scheduled start time (11:00) of the phone conference, that is, before the risk time zone 960 starts, by using the meeting point DB 760 and the timetable DB 410. Specifically, the route setting unit 403 compares the GPS position 772 of the first moving body 100 with the GPS position 72 of each meeting point of the meeting point DB 760 and with the GPS position indicated by the ID 411 of each station of the timetable DB 410. Then, based on the comparison result, the route setting unit 403 determines the closest point or the closest station in the timetable DB 410 from the first moving body 100, among the meeting points in the meeting point DB 760, to be a candidate of the meeting point where the user Y makes a transfer.

Here, the destination of user Y is a “B station”. The route setting unit 403 searches the timetable DB 410, and based on the result of the search, extracts one or more time points 412 with the time of departure from the “B station” being earlier than the arrival time at the destination designated by the user Y, among a plurality of time points 412 corresponding to a closest “A station” that is a candidate of the meeting point. In the case of the timetable DB 410 of FIG. 17, “12:50” and “13:20” are extracted as the time 412 corresponding to the “B station”. In the timetable DB 410, the route setting unit 403 identifies “11:10” and “11:40” as departure times from the “A station” respectively corresponding to “12:50” and “13:20” extracted.

First of all, the route setting unit 403 calculates the route from the position of the moving body 100 to the “B station” via the “A station” which is the meeting point, and the distance between the points. The route setting unit 403 determines whether the first moving body 100 can reach the destination of the user X by the designated time, based on the distance from the position 772 of the first moving body 100 to the destination via the “A station” and the speed 773 of the first moving body 100. When it is determined that the destination of the user X can be reached by the designated time, the route setting unit 403 determines whether the first moving body 100 can arrive before “11:10” or within “11:10” to “11:40”, based on the time required for moving to the “A station” calculated based on the distance to the “A station” as the meeting point from the position of the first moving body 100 and the speed 773. When it is determined that thus arriving is possible, the route setting unit 403 determines the “A station” to be the meeting point 40, and the user Y transfers to the railway at the meeting point A. For example, the first moving body 100 arrives at the “A station” at 10:50.

As a result, the shared state of the first moving body 100 will be resolved at 10:50, whereby the confidential information handled by the user X during the phone conference scheduled to start from 11:00 can be protected from a security risk such as information leakage to a fellow passenger. Furthermore, the user Y who has transferred to the railway at the meeting point 40 (“A station”) in order to resolve the shared state, can arrive at the destination “B station” by the designated time.

<K. Modification>

In the above-described embodiment, any fellow passenger is determined to be transferred. Alternatively, the route setting unit 403 may set the route for transfer when the user sharing a ride (the user Y for example) satisfies a predetermined condition.

For example, the route setting unit 403 determines whether the user X and the user Y who share a ride are in the same group regarding the schedule (for example, a phone conference) involving handling confidential information, and sets the route upon determining that a condition for them to be in the same group is satisfied.

Specifically, when each user's schedule (such as the subject 953) includes information about a communication counterpart (such as communication address and email address, for example), the route setting unit 403 determines that the user X and the user Y are in the same group if the corresponding information about the communication counterpart is the same between the user X and the user Y.

Furthermore, the schedule (subject 953) of the action 954 corresponding to each of a plurality of users may include participation information indicating whether the user is a member involved in the schedule for handling confidential information. In such a case, the route setting unit 403 determines that the same group is composed of members who are involved in the schedule for handling the same confidential information.

Furthermore, the schedule for handling confidential information (action 954) includes a conference (such as phone conference or video conference) handling the confidential information. The route setting unit 403 may determine that the user X and the second user Y belong to the same group when the first moving body 100 is equipped with the equipment for such a conference.

In addition, when the route passing through the meeting point 40 is calculated, the route setting unit 403 sets the route for at least one of the first moving body 100 and the second moving body 100. For example, when the meeting point 40 is on the original route of the first moving body 100, the route of the first moving body 100 does not need to be changed, and therefore the route setting unit 403 sets a route passing through the meeting point 40 for the second moving body 100.

Therefore, the route notification unit 404 also transmits the route notification set by the route setting unit 403 to the at least one moving body 100.

<L. Program>

In the present embodiment, a program for causing the CPU 701 of the management server 700 to execute the above-described processing is provided. Such a program includes at least the moving body management program 730 for executing the processing according to the flowchart of FIG. 15. Such a program may also be recorded in a computer-readable storage medium such as the storage medium 708, a flexible disk, a Compact Disk-Read Only Memory (CD-ROM), a ROM, a RAM, and a memory card provided to a computer of the management server 700, to be provided as a program product. Alternatively, the program can be provided while being recorded in a storage medium such as an HDD 706 or Solid State Drive (SSD) embedded in the computer. The program can also be provided by downloading via the network 720. The program may be executed by one or more processors such as the CPU 701, or a combination of the processor and a circuit such as an ASIC and an FPGA.

In the present embodiment, a program for causing the information processing apparatus 30 to execute the above-described processing is provided. Such a program includes at least the moving body management program 312 for executing the processing according to the flowchart of FIG. 15. Such a program may also be recorded in a computer-readable storage medium such as the storage medium 345, a flexible disk, a Compact Disk-Read Only Memory (CD-ROM), a ROM, a RAM, and a memory card provided to a computer of the information processing apparatus 30, to be provided as a program product. Alternatively, the program can be provided while being recorded in a storage medium such as an HDD 310 or an SSD embedded in the computer. The program can also be provided by downloading via the network 720. The program may be executed by one or more processors such as the CPU 300, or a combination of the processor and a circuit such as an ASIC and an FPGA.

The program may be one for calling a required modules among program modules provided as a part of the OS of the computer in a predetermined sequence at a predetermined timing, and causing the processor to execute the module. In such a case, the program itself does not include the above module, and the process is executed in cooperation with the OS. A program that does not include such a module may also be included in the program of each embodiment.

Furthermore, the program according to the present embodiment may be provided while being incorporated in a part of another program. Also in such a case, the program itself does not include the module included in the other program, and causes the processor to execute the processing in cooperation with the other program. The program according to the present embodiment may include a program incorporated in such another program.

<M. Effect of Embodiment>

According to the present embodiment, when a service that allows a plurality of users to share the moving body 100 (pooling) is provided, if a user is scheduled to take the action 954 for handling confidential information, the shared state is resolved before the action 954 starts. Thus, the confidential information can be protected from a security risk such as leakage to a fellow passenger, even when the user takes the scheduled action 954 inside the moving body.

Furthermore, the meeting point closest to the moving body 100 is determined to be the meeting point 40 where the user transfers to another moving body for resolving the shared state. Alternatively, as illustrated in step S13 in FIG. 15, determination on whether the moving body 100 can meet another moving body is performed with another moving body positioned closer to the moving body 100. Thus, wait time before the transfer after the action 954 handling confidential information is scheduled can be made shorter.

Furthermore, despite the movement to the destination via the meeting point 40 as described above, each user is guaranteed to reach his or her destination by the designated time.

Although embodiments of the present invention have been described and illustrated in detail, the disclosed embodiments are made for purposes of illustration and example only and not limitation. The scope of the present invention should not be interpreted by terms of the above description but by terms of the appended claims, and is intended to include any modification within the meaning and scope equivalent to the claims

What is claimed is:

1. A system comprising:
a hardware processor that:
determines whether a schedule of a first user related to handling confidential information has occurred, based on a schedule of an action corresponding to each of a plurality of users; and
determines whether a second user is on a first moving body carrying the first user based on a boarding/alighting schedule of moving bodies each moving along a route on a map; and
a movement information setter that sets movement information related to movement of each of the moving bodies, wherein
the movement information setter sets, when the first user is determined to be scheduled to handle the confidential information while being in the first moving body with the second user also being in the first moving body, the movement information to make the first moving body and a second moving body for transfer meet.

2. The system according to claim 1, wherein the movement information includes at least one of a meeting point where the first moving body and the second moving body meet and a meeting route that is a movement route to the meeting point.

3. The system according to claim 1, wherein
the schedule related to handling the confidential information includes scheduled time for starting to handle the confidential information, and
the movement information setter sets the movement information to make the first moving body and the second moving body for transfer meet before the scheduled time or within a predetermined time period from the scheduled time.

4. The system according to claim 3, wherein
the route on the map includes a plurality of meeting points that allow meeting of the moving bodies, and
the movement information setter sets the movement information to make the first moving body and the second moving body for transfer meet at one of the plurality of meeting points.

5. The system according to claim 4, wherein the movement information setter selects the second moving body from the plurality of moving bodies based on a position of and empty information about each of the moving bodies.

6. The system according to claim 4, wherein the one meeting point includes a position closest to the first moving body or the second moving body.

7. The system according to claim 1, wherein the movement information setter further sets speed of the moving bodies to make the first moving body and the second moving body for transfer meet.

8. The system according to claim 1, wherein
the second moving body includes public transportation operated under an operation schedule, and
the movement information setter sets the movement information based on the operation schedule to make the first moving body and the second moving body meet.

9. The system according to claim 1, wherein the movement information setter further determines whether the first user and the second user are in a same group regarding the schedule related to handling the confidential information, and sets the movement information when the first user and the second user are determined to be in the same group.

10. The system according to claim 9, wherein
the schedule of each of the users includes communication counterpart information indicating a counterpart with whom the user communicates, and
the movement information setter determines that the first user and the second user corresponding to the common communication counterpart information are in a same group.

11. The system according to claim 9, wherein
a schedule of the action corresponding to each of a plurality of users includes participation information indicating whether the user is a member to participate in the schedule related to handling the confidential information, and
the same group includes members participating in the schedule related to handling the common confidential information.

12. The system according to claim 9, wherein
the schedule related to handling the confidential information includes a conference handling the confidential information, and
when the first moving body includes equipment for the conference, the movement information setter determines that the first user and the second user are in a same group for the schedule related to handling the confidential information.

13. The system according to claim 1, wherein the movement information setter sets the movement information for at least one of the first moving body and the second moving body.

14. The system according to claim 13, wherein the hardware processor transmits a notification indicating the movement information set by the movement information setter to the at least one of the first moving body and the second moving body.

15. An information processing apparatus comprising:
a hardware processor that:
determines whether a schedule of a first user related to handling confidential information has occurred, based on a schedule of an action corresponding to each of a plurality of users; and
determines whether a second user is on a first moving body carrying the first user based on a boarding/alighting schedule of moving bodies each moving along a route on a map; and
a movement information setter that sets movement information related to movement of each of the moving bodies, wherein
the movement information setter sets, when the first user is determined to be scheduled to handle the confidential information while being in the first moving body with the second user also being in the first moving body, the movement information to make the first moving body and a second moving body for transfer meet.

16. A non-transitory recording medium storing a computer readable program causing a computer to execute movement control related to a plurality of moving bodies, comprising:
determining whether a schedule of a first user related to handling confidential information has occurred, based on a schedule of an action corresponding to each of a plurality of users;
determining whether a second user is on a first moving body carrying the first user based on a boarding/alighting schedule of moving bodies each moving along a route on a map; and
setting movement information related to movement of each of the moving bodies, wherein
the setting includes setting, when the first user is determined to be scheduled to handle the confidential information while being in the first moving body with the second user also being in the first moving body, the movement information to make the first moving body and a second moving body for transfer meet.
